(19) United States
(12) Patent Application Publication
(10) Pub. No.: US 2026/0088705 A1
(43) Pub. Date: Mar. 26, 2026

(54) CONTROL METHOD FOR FLYING CAPACITOR VOLTAGE AND MULTI-LEVEL CONVERSION CIRCUIT EMPLOYING SAME

(71) Applicant: Delta Electronics (Shanghai) Co., Ltd., Shanghai (CN)

(72) Inventors: Yichao Wang, Shanghai (CN); Yuhua Hu, Shanghai (CN); Kai Dong, Shanghai (CN); Jinfa Zhang, Shanghai (CN)

(21) Appl. No.: 19/401,049

(22) Filed: Nov. 25, 2025

Related U.S. Application Data
(63) Continuation-in-part of application No. 18/372,615, filed on Sep. 25, 2023, now Pat. No. 12,512,768.

(30) Foreign Application Priority Data
Nov. 9, 2022 (CN) 202211400030.2
Jun. 19, 2025 (CN) 202510828760.X

(51) Int. Cl. H02M 1/00; H02M 3/158; H02M 7/25

(52) U.S. Cl. CPC H02M 1/0095; H02M 3/1586; H02M 7/25

(57) ABSTRACT

A control method for flying capacitor voltage and multi-level conversion circuit employing same are provided. In the multi-level conversion circuit, all lower switches are connected in series between an inductor and a negative output terminal, and all upper switches are connected in series between the inductor and a positive output terminal. Every flying capacitor is connected between a common connection node of the lower switches and a common connection node of the upper switches. When working in DCM, the control method includes steps of (a) regarding the lower switches and the upper switches as main switches and synchronous rectification switches, and (b) adjusting duty ratios of driving signals of the main switches according to adjustment values corresponding to the flying capacitors connected thereto, and adjusting phase-shift angles between driving signals of any two neighboring main switches according to the acquired adjustment values.

### CROSS-REFERENCE TO RELATED APPLICATION

This application is a continuation-in-part application of U.S. application Ser. No. 18/372,615 filed on Sep. 25, 2023, which claims priority to China Patent Application No. 202211400030.2, filed on Nov. 9, 2022. This application also claims priority to China Patent Application No. 202510828760.X filed on Jun. 19, 2025. The entire contents of which are incorporated herein by reference for all purposes.

### FIELD OF THE INVENTION

The present disclosure relates to a voltage control method, and more particularly to a flying capacitor voltage control method and a multi-level conversion circuit using the same.

### BACKGROUND OF THE INVENTION

In the multi-level circuit including flying capacitors, the voltage across flying capacitor has to be controlled and stabilized for avoiding affecting the normal working status of circuit or even damaging the switches due to overvoltage.

Conventionally, the polarity of the current in the multi-level circuit is detected to determine whether to increase or decrease flying capacitor voltage, so as to make the flying capacitor voltage stable. However, under light load conditions, the current ripple caused by high-frequency switching causes the current direction to change repeatedly. Further, the sampling error also exists. Consequently, it may result in affecting the reliability of the balance control for flying capacitor voltage. Furthermore, based on the input voltage, the output voltage and the load, the multi-level circuit may switch between CCM (continuous conduction mode) and DCM (discontinuous conduction mode. However, during switching between CCM and DCM, the transition state is not smooth, causing the flying capacitor voltage to jitter, which also affects the reliability of the balance control for flying capacitor voltage.

Therefore, there is a need of providing a control method for flying capacitor voltage and a multi-level conversion circuit employing the same in order to overcome the drawbacks of the conventional technologies.

### SUMMARY OF THE INVENTION

The present disclosure provides a control method for flying capacitor voltage and a multi-level conversion circuit employing the same. The control method and the multi-level conversion circuit may be applied in CCM and DCM to balance the flying capacitor voltage through controlling the duty ratio of switch and the phase-shift angle between switches, so that there is no need to determine the polarity of current, thereby preventing the charging and discharging of the flying capacitor from being affected by misjudging the polarity of current. Further, the switching between CCM and DCM also becomes more frequent to smooth the transition state, thereby preventing the flying capacitor voltage from jittering. Consequently, the reliability of the balance control for flying capacitor voltage can be improved.

In accordance with an aspect of the present disclosure, a control method for flying capacitor voltage applied in a multi-level conversion circuit is provided. The number of levels of the multi-level conversion circuit is N which is an integer greater than or equal to three. The multi-level conversion circuit includes a first input terminal, a second input terminal, an inductor, N−1 lower switches, N−1 upper switches, N−2 flying capacitors, a positive output terminal and a negative output terminal. The first input terminal and the second input terminal are configured to connect to a power source. The positive output terminal and the negative output terminal are configured to provide an output voltage. A first terminal of the inductor is electrically connected to the first input terminal. The N−1 lower switches are connected in series between the second terminal of the inductor and the negative output terminal. Specifically, the first lower switch of these N−1 lower switches is coupled to the second terminal of the inductor, and the (N−1)th lower switch is coupled to the negative output terminal. The N−1 upper switches are connected in series between the second terminal of the inductor and the positive output terminal, and the first upper switch and the (N−1)th upper switch are coupled to the second terminal of the inductor and the positive output terminal respectively. The kth flying capacitor is connected between a common connection node of the kth lower switch and the (k+1)th lower switch and a common connection node of the kth upper switch and the (k+1)th upper switch, and k is a positive integer less than or equal to N−2. When the power source is DC power source, the negative output terminal is electrically connected to the second input terminal. When the power source is AC power source, the multi-level conversion circuit further includes a first input switch and a second input switch. The first input switch is coupled between the first input terminal and the positive output terminal, the second input switch is coupled between the first input terminal and the negative output terminal, and a control signal of the first input switch is complementary to a control signal of the second input switch. The control method includes steps of: (a) regarding the N−1 lower switches as N−1 main switches and regarding the N−1 upper switches as N−1 synchronous rectification switches when the potential at the first input terminal is higher than the potential at the second input terminal, and regarding the N−1 lower switches as N−1 synchronous rectification switches and regarding the N−1 upper switches as N−1 main switches when the potential at the first input terminal is lower than the potential at the second input terminal; and (b) acquiring an adjustment value corresponding to each flying capacitor according to an actual voltage and a reference voltage of the flying capacitor; wherein when the multi-level conversion circuit works in DCM, according to the acquired adjustment value, the duty ratios of driving signals of the N−1 main switches and the phase-shift angles between driving signals of any two neighboring main switches of the N−1 main switches are adjusted respectively.

In accordance with another aspect of the present disclosure, a multi-level conversion circuit is provided. The number of levels of the multi-level conversion circuit is N which is an integer greater than or equal to three. The multi-level conversion circuit includes a first input terminal and a second input terminal configured to electrically connect to a power source; a positive output terminal and a negative output terminal configured to provide an output voltage, wherein when the power source is DC power source, the negative output terminal is electrically connected to the second input terminal; an inductor having a first terminal electrically connected to the first input terminal; N−1 lower switches connected in series between a second terminal of the inductor and the negative output terminal, wherein the first lower switch and the (N−1)th lower switch are coupled to the second terminal of the inductor and the negative output terminal respectively; N−1 upper switches connected in series between the second terminal of the inductor and the positive output terminal, wherein the first upper switch and the (N−1)th upper switch are coupled to the second terminal of the inductor and the positive output terminal respectively; and N−2 flying capacitors, wherein the kth flying capacitor is connected between a common connection node of the kth lower switch and the (k+1)th lower switch and a common connection node of the kth upper switch and the (k+1)th upper switch, and k is a positive integer less than or equal to N−2, and wherein when the power source is AC power source, the multi-level conversion circuit further includes a first input switch and a second input switch, the first input switch is coupled between the first input terminal and the positive output terminal, the second input switch is coupled between the first input terminal and the negative output terminal, and a control signal of the first input switch is complementary to a control signal of the second input switch; and a control unit is configured to: regard the N−1 lower switches as N−1 main switches and regard the N−1 upper switches as N−1 synchronous rectification switches when a potential at the first input terminal is higher than a potential at the second input terminal, and regard the N−1 lower switches as N−1 synchronous rectification switches and regard the N−1 upper switches as N−1 main switches when the potential at the first input terminal is lower than the potential at the second input terminal; and sample an actual voltage across two terminals of each flying capacitor and acquire an adjustment value corresponding to each flying capacitor according to the actual voltage and a reference voltage of the flying capacitor, wherein when the multi-level conversion circuit works in DCM, according to the acquired adjustment value, the duty ratios of driving signals of the N−1 main switches and the phase-shift angles between driving signals of any two neighboring main switches of the N−1 main switches are adjusted respectively.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a flow chart illustrating a control method according to an embodiment of the present disclosure;

FIG. 2A is a schematic circuit diagram illustrating a multi-level DC-DC conversion circuit employing the control method shown in FIG. 1 according to an embodiment of the present disclosure;

FIG. 2B is a schematic circuit diagram illustrating a multi-level AC-DC conversion circuit employing the control method shown in FIG. 1 according to an embodiment of the present disclosure;

FIG. 3 schematically shows a part of the flying capacitors, main switches and synchronous rectification switches in the multi-level DC-DC conversion circuit;

FIGS. 4A, 4B, 4C and 4D show the charging state, discharging state and bypass state of the flying capacitor in FIG. 3;

FIG. 5 schematically shows the relation between the charging and discharging time lengths of the flying capacitor and the switching state of the neighboring main switches;

FIG. 6 is a schematic block diagram illustrating a control unit in FIG. 2A or FIG. 2B of the present disclosure;

FIG. 7 is a circuit diagram showing the multi-level AC-DC conversion circuit of FIG. 1 with N=3;

FIG. 8A schematically shows the waveforms of the multi-level DC-DC conversion circuit of FIG. 7 working in DCM with D<1/(N−1), wherein the adjustment value Δd₁ is greater than 0, and the absolute value of the adjustment value Δd₁ is less than or equal to |D−D_{ccm}|;

FIG. 8B schematically shows the waveforms of the multi-level DC-DC conversion circuit of FIG. 7 working in DCM with D<1/(N−1), wherein the adjustment value Δd₁ is less than 0, and the absolute value of the adjustment value Δd₁ is less than or equal to |D−D_{ccm}|;

FIG. 9A schematically shows the waveforms of the multi-level DC-DC conversion circuit of FIG. 7 working in DCM with D>1/(N−1), wherein the adjustment value Δd₁ is greater than 0, and the absolute value of the adjustment value Δd₁ is less than or equal to |D−D_{ccm}|; and

FIG. 9B schematically shows the waveforms of the multi-level DC-DC conversion circuit of FIG. 7 working in DCM with D>1/(N−1), wherein the adjustment value Δd₁ is less than 0, and the absolute value of the adjustment value Δd₁ is less than or equal to |D−D_{ccm}|.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

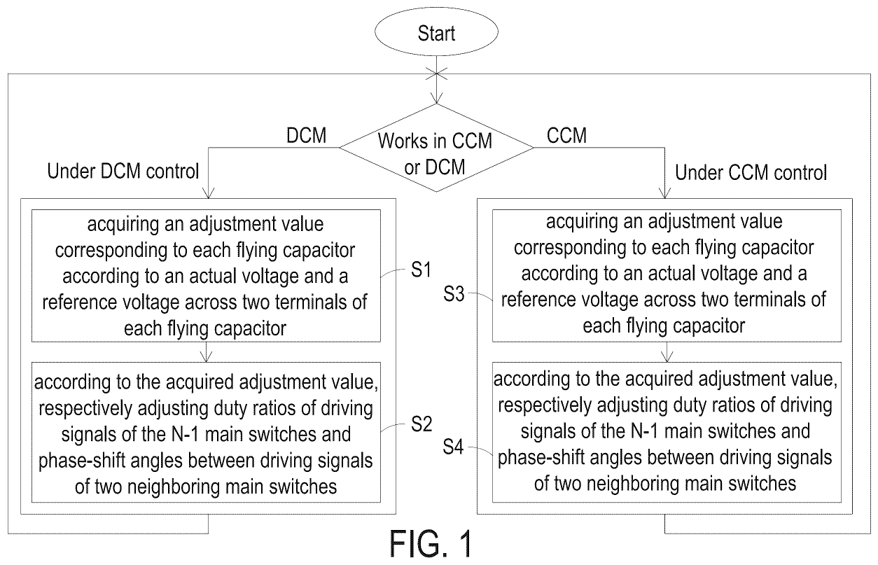

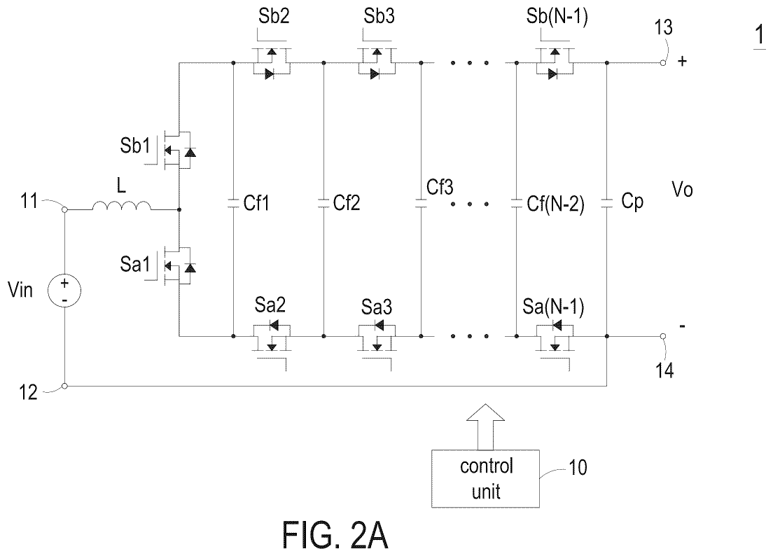

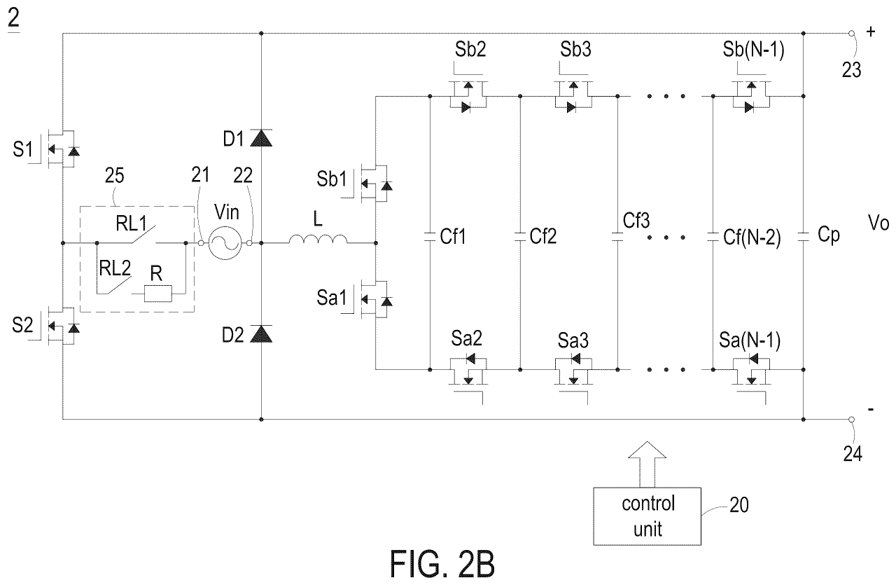

Please refer to FIG. 1, FIG. 2A and FIG. 2B. FIG. 1 is a flow chart illustrating a control method according to an embodiment of the present disclosure, FIG. 2A is a schematic circuit diagram illustrating a multi-level DC-DC conversion circuit employing the control method shown in FIG. 1 according to an embodiment of the present disclosure, and FIG. 2B is a schematic circuit diagram illustrating a multi-level AC-DC conversion circuit employing the control method shown in FIG. 1 according to an embodiment of the present disclosure. The control method of the present disclosure may be applied in the multi-level conversion circuit, such as the multi-level DC-DC conversion circuit 1 shown in FIG. 2A, or the multi-level AC-DC conversion circuit 2 shown in FIG. 2B.

The number of levels of the multi-level DC-DC conversion circuit 1 is N, which is an integer greater than or equal to three. The multi-level DC-DC conversion circuit 1 includes a first input terminal 11, a second input terminal 12, a positive output terminal 13, a negative output terminal 14, an inductor L, N−1 lower switches Sa1, Sa2, . . . , Sa(N−1), N−1 upper switches Sb1, Sb2, . . . , Sb(N−1), N−2 flying capacitors Cf1, Cf2, . . . , Cf(N−2), and a control unit 10. The first input terminal 11 and the second input terminal 12 are configured to connect to a power source (DC power source) for receiving an input voltage Vin. The positive output terminal 13 and the negative output terminal 14 are configured to provide an output voltage Vo, and the negative output terminal 14 is electrically connected to the second input terminal 12. A first terminal of the inductor L is electrically connected to the first input terminal 11. All the lower switches Sa1, Sa2, . . . , Sa(N−1) are connected in series between a second terminal of the inductor L and the negative output terminal 14, and the first lower switch Sa1 and the (N−1)th lower switch Sa(N−1) are coupled to the second terminal of the inductor L and the negative output terminal 14 respectively. All the upper switches Sb1, Sb2, . . . , Sb(N−1) are connected in series between the second terminal of the inductor L and the positive output terminal 13, and the first upper switch Sb1 and the (N−1)th upper switch Sb(N−1) are coupled to the second terminal of the inductor L and the positive output terminal 13 respectively. In all the N−2 flying capacitors Cf1, Cf2, . . . , Cf(N−2), the kth flying capacitor Cfk is connected between a common connection node of the kth lower switch Sak and the (k+1)th lower switch Sa(k+1) and a common connection node of the kth upper switch Sbk and the (k+1)th upper switch Sb(k+1), where k is a positive integer less than or equal to N−2 (i.e., k=1, 2, . . . , (N−2)). The control unit 10 is configured to control the operation of all switches in the multi-level DC-DC conversion circuit 1 and perform the control method of the present disclosure.

During the process of controlling the switches, the control unit 10 regards all the N−1 lower switches Sa1, Sa2, . . . , Sa(N−1) as main switches, and regards all the N−1 upper switches Sb1, Sb2, . . . , Sb(N−1) as synchronous rectification switches. In an embodiment, the multi-level DC-DC conversion circuit 1 further includes an output capacitor Cp connected between the positive output terminal 13 and the negative output terminal 14 to make the output voltage Vo stable.

As shown in FIG. 2B, the number of levels of the multi-level AC-DC conversion circuit 2 is N. The multi-level AC-DC conversion circuit 2 includes a first input terminal 21, a second input terminal 22, a first output terminal 23, a second output terminal 24, an inductor L, N−1 lower switches Sa1, Sa2, . . . , Sa(N−1), N−1 upper switches Sb1, Sb2, . . . , Sb(N−1), N−2 flying capacitors Cf1, Cf2, . . . , Cf(N−2), a first input switch S1, a second input switch S2, and a control unit 20. The first input terminal 21 and the second input terminal 22 are configured to connect to a power source (AC power source) for receiving an input voltage Vin. The first output terminal 23 and the second output terminal 24 are configured to provide an output voltage Vo. A first terminal of the inductor L is electrically connected to the second input terminal 22. All the lower switches Sa1, Sa2, . . . , Sa(N−1) are connected in series between a second terminal of the inductor L and the second output terminal 24, and the first lower switch Sa1 and the (N−1)th lower switch Sa(N−1) are coupled to the second terminal of the inductor L and the second output terminal 24 respectively. All the upper switches Sb1, Sb2, . . . , Sb(N−1) are connected in series between the second terminal of the inductor L and the first output terminal 23, and the first upper switch Sb1 and the (N−1)th upper switch Sb(N−1) are coupled to the second terminal of the inductor L and the first output terminal 23 respectively. In all the N−2 flying capacitors Cf1, Cf2, . . . , Cf(N−2), the kth flying capacitor Cfk is connected between a common connection node of the kth lower switch Sak and the (k+1)th lower switch Sa(k+1) and a common connection node of the kth upper switch Sbk and the (k+1)th upper switch Sb(k+1). The first input switch S1 is coupled between the first input terminal 21 and the first output terminal 23, and the second input switch S2 is coupled between the first input terminal 21 and the second output terminal 24. The control signal of first input switch S1 is complementary to the control signal of second input switch S2. The control unit 20 is configured to control the operation of all switches in the multi-level AC-DC conversion circuit 2 and perform the control method of the present disclosure.

During the process of controlling the switches, when the potential at the first input terminal 21 is lower than the potential at the second input terminal 22, the control unit 20 regards the N−1 lower switches Sa1, Sa2, . . . , Sa(N−1) and the N−1 upper switches Sb1, Sb2, . . . , Sb(N−1) as N−1 synchronous rectification switches and N−1 main switches respectively. Alternatively, when the potential at the first input terminal 21 is higher than the potential at the second input terminal 22, the control unit 20 regards the N−1 upper switches Sb1, Sb2, . . . , Sb(N−1) and the N−1 lower switches Sa1, Sa2, . . . , Sa(N−1) as N−1 synchronous rectification switches and N−1 main switches respectively. In detail, the first input switch S1 and the second input switch S2 are switched according to the polarity of the input voltage Vin. When the input voltage Vin is in the negative half cycle (i.e., the potential at the first input terminal 21 is higher than the potential at the second input terminal 22), the first input switch S1 and the second input switch S2 are in the on state and the off state respectively, and the control unit 20 regards all the N−1 upper switches Sb1, Sb2, . . . , Sb(N−1) as synchronous rectification switches and regards all the N−1 lower switches Sa1, Sa2, . . . , Sa(N−1) as main switches. On the contrary, when the input voltage Vin is in the positive half cycle (i.e., the potential at the first input terminal 21 is lower than the potential at the second input terminal 22), the first input switch S1 and the second input switch S2 are in the off state and the on state respectively, and the control unit 20 regards all the N−1 lower switches Sa1, Sa2, . . . , Sa(N−1) as synchronous rectification switches and regards all the N−1 upper switches Sb1, Sb2, . . . , Sb(N−1) as main switches.

In an embodiment, the multi-level AC-DC conversion circuit 2 further includes an output capacitor Cp connected between the first output terminal 23 and the second output terminal 24 to make the output voltage Vo stable. In an embodiment, the multi-level AC-DC conversion circuit 2 further includes diodes D1 and D2. The cathode terminal and the anode terminal of the diode D1 are electrically connected to the first output terminal 23 and the second input terminal 22 respectively. The cathode terminal and the anode terminal of the diode D2 are electrically connected to the second input terminal 22 and the second output terminal 24 respectively. In an embodiment, the multi-level AC-DC conversion circuit 2 further includes an inrush current limiter 25. The inrush current limiter 25 is utilized to limit the inrush current for preventing the inrush current from damaging the components of the multi-level AC-DC conversion circuit 2. The inrush current limiter 25 includes a resistor R and switches RL1 and RL2. Two terminals of the switch RL1 are electrically connected to the first input terminal 21 and a common connection node of the first input switch S1 and the second input switch S2 respectively. The branch circuit formed by the resistor R and the switch RL2 connected in series is connected between the two terminals of the switch RL1.

In the multi-level DC-DC conversion circuit 1 and the multi-level AC-DC conversion circuit 2, according to the polarity of the input voltage Vin, the upper switches or the lower switches are regarded as the main switches, and the others are regarded as the synchronous rectification switches. The multi-level DC-DC conversion circuit 1 is switched to work in CCM (continuous conduction mode) or DCM (discontinuous conduction mode) according to the variation of the input voltage Vin, output voltage Vo and load.

If it is determined that the multi-level DC-DC conversion circuit 1 works in CCM, a CCM control method is adopted; and if it is determined that the multi-level DC-DC conversion circuit 1 works in DCM, a DCM control method is adopted. If it is determined that the multi-level AC-DC conversion circuit 2 works in CCM, the CCM control method is adopted; and if it is determined that the multi-level AC-DC conversion circuit 2 works in DCM, the DCM control method is adopted. Since the multi-level DC-DC conversion circuit 1 or the multi-level AC-DC conversion circuit 2 may be switched to work in CCM or DCM, whether the multi-level DC-DC conversion circuit 1 or the multi-level AC-DC conversion circuit 2 currently works in CCM or DCM has to be determined again after performing the CCM or DCM control method for a period of time (e.g., one switching cycle), so as to adopt the control method corresponding to the working mode at present.

The way of determining whether the multi-level DC-DC conversion circuit 1 and the multi-level AC-DC conversion circuit 2 currently work in CCM or DCM is exemplified as follows. This determining way can be applied to the multi-level DC-DC conversion circuit 1 and the multi-level AC-DC conversion circuit 2, and thus the term “multi-level conversion circuit” is used in the description below to represent these two kinds of multi-level conversion circuits. Firstly, the theoretical duty ratios of the main switch for the multi-level conversion circuit in CCM and DCM are calculated using the following equations:

$$1. For CCM :$$

$${D}_{C C M} = 1 - \frac{{V}_{i n}}{{V}_{o}}$$

$$2. For DCM :$$

$${D}_{D C M} = \frac{h {T}_{θ}}{T s} + {[ \frac{2 L {i}_{L}}{{T}_{s} {V}_{o}} \frac{{D}_{C C M} - \frac{h {T}_{θ}}{T s}}{\frac{( h + 1 ) {T}_{θ}}{Ts} - {D}_{C C M}} ]}^{\frac{1}{2}} , \frac{{D}_{CCM} {T}_{S}}{{T}_{θ}} - 1 \leq h < \frac{{D}_{C C M} {T}_{S}}{{T}_{θ}}$$

$${T}_{θ} = Ts / ( N - 1 ) ,$$

where D_{CCM} is the theoretical value of duty ratio of the main switch when the multi-level conversion circuit works in CCM, T_{θ} is the time length corresponding to the phase-shift angle θ between any two neighboring main switches, θ=360°/(N−1), Ts is the switching period of the main switch, h is an integer, D_{DCM} is the theoretical value of duty ratio of the main switch when the multi-level conversion circuit works in DCM, and it is the current flowing through the inductor L. The multi-level conversion circuit works in CCM when D_{CCM}≤D_{DCM}, and the multi-level conversion circuit works in DCM when D_{CCM}>D_{DCM}.

In an embodiment, whether the multi-level conversion circuit works in CCM or DCM may be determined by detecting if the current flowing through the inductor L crosses zero. If it is detected that the current flowing through the inductor L crosses zero, the multi-level conversion circuit currently works in DCM, and the DCM control method is adopted. If it is detected that the current flowing through the inductor L doesn't cross zero, and the multi-level conversion circuit currently works in CCM, the CCM control method is adopted. It is noted that whether the current flowing through the inductor L crosses zero may be determined by detecting the current flowing through the inductor L directly or by detecting other parameters, which can reflect whether the current crosses zero, in the multi-level conversion circuit.

The CCM control method adopted in the multi-level DC-DC conversion circuit 1 and the CCM control method adopted in the multi-level AC-DC conversion circuit 2 are the same, and the DCM control method adopted in the multi-level DC-DC conversion circuit 1 and the DCM control method adopted in the multi-level AC-DC conversion circuit 2 are the same. Therefore, the CCM and DCM control methods are described in detail as follows based on the multi-level DC-DC conversion circuit 1 only. Further, since one of the lower switch and upper switch and the other thereof are the main switch and the synchronous rectification switch respectively, the description for the control methods (including CCM and DCM control methods) of the present disclosure as follows focuses on the control for the main switch, and the lower switches Sa1, Sa2, . . . , Sa(N−1) are regarded as the main switches (i.e., the main switches Sa1, Sa2, . . . , Sa(N−1)) as an example. For the case that the upper switches Sb1, Sb2, . . . , Sb(N−1) are regarded as the main switches, the control for the main switches is applied to the upper switches Sb1, Sb2, . . . , Sb(N−1), and thus the detailed descriptions are omitted herein. In addition, it is noted that the control methods mentioned in the present disclosure are all performed by the control unit 10 or 20 shown in FIG. 2A or FIG. 2B.

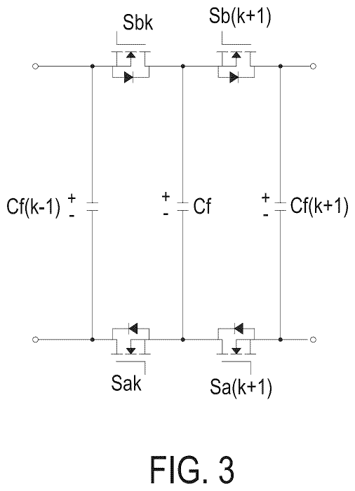

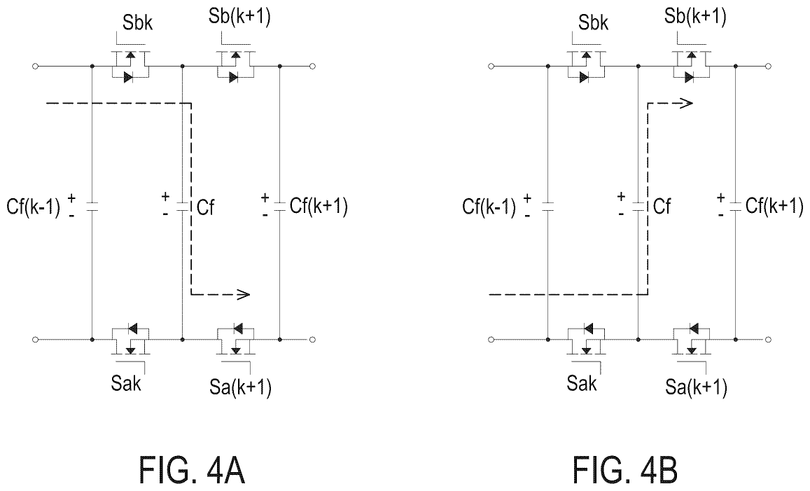

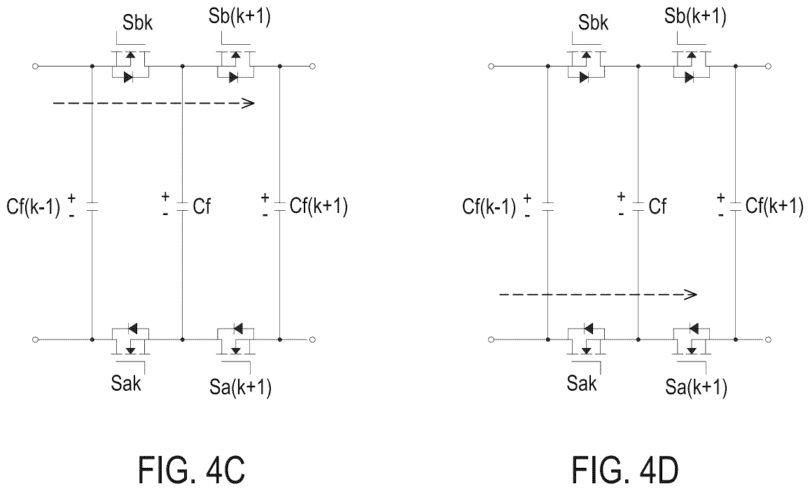

In the multi-level conversion circuit, whether the flying capacitor is charged or discharged depends on the switching state (on or off) of the neighboring switch, which would be described as follows according to FIG. 3, FIG. 4A, FIG. 4B, FIG. 4C and FIG. 4D. FIG. 3 shows a part of the flying capacitors, main switches and synchronous rectification switches in the multi-level conversion circuit, including the kth, (k−1)th and (k+1)th flying capacitors Cfk, Cf(k−1) and Cf(k+1), the kth and (k+1)th main switches Sak and Sa(k+1), and the kth and (k+1)th synchronous rectification switches Sbk and Sb(k+1). In the example shown in FIG. 3, 1<k<N−2. In addition, the flying capacitor Cf(k−1) is deleted when k=1, and the flying capacitor Cf(k+1) is replaced by the output capacitor Cp when k=N−2. FIGS. 4A, 4B, 4C and 4D show the charging state, discharging state and bypass state of the flying capacitor Cfk in FIG. 3, and the current path is depicted by dotted lines with arrow. As shown in FIG. 4A, when the main switches Sak and Sa(k+1) are turned off and turned on respectively, the synchronous rectification switches Sbk and Sb(k+1) are turned on and turned off respectively, and the flying capacitor Cfk is charged to be in the charging state. As shown in FIG. 4B, when the main switches Sak and Sa(k+1) are turned on and turned off respectively, the synchronous rectification switches Sbk and Sb(k+1) are turned off and turned on respectively, and the flying capacitor Cfk is discharged to be in the discharging state. As shown in FIG. 4C, when the main switches Sak and Sa(k+1) are both turned off, the synchronous rectification switches Sbk and Sb(k+1) are both turned on. At this time, since the current doesn't flow through the flying capacitor Cfk, the flying capacitor Cfk is in the bypass state and is neither charged nor discharged. As shown in FIG. 4D, when the main switches Sak and Sa(k+1) are both turned on, the synchronous rectification switches Sbk and Sb(k+1) are both turned off. At this time, since the current doesn't flow through the flying capacitor Cfk, the flying capacitor Cfk is in the bypass state and is neither charged nor discharged.

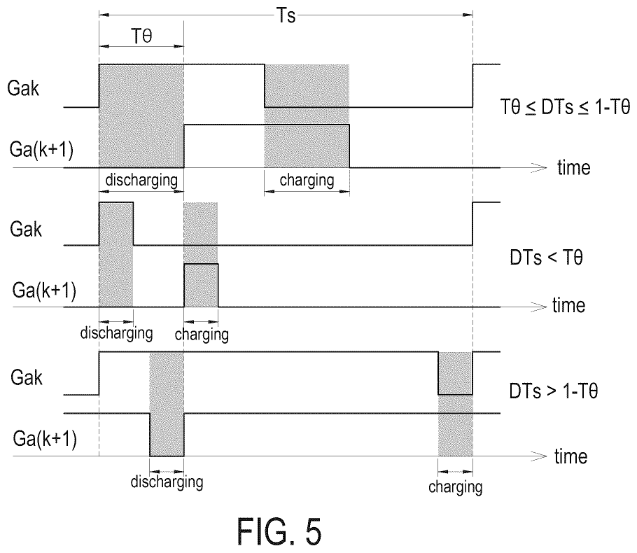

FIG. 5 schematically shows the relation between the charging and discharging time lengths of the flying capacitor and the switching state of the neighboring main switches. In FIG. 5, Gak and Ga(k+1) represent the control signals of the main switches Sak and Sa(k+1) respectively, D is the duty ratio of switches, and the shadow part is the time period of charging or discharging the flying capacitor Cfk. In the multi-level DC-DC conversion circuit, the initial duty ratio of each main switch is equal to the duty ratio D. As shown in FIG. 5, the waveforms of the control signals Gak and Ga(k+1) of the main switches Sak and Sa(k+1) under T_{θ}≤DTs≤1−T_{θ}, under DTs<T_{θ}, and under DTs>1−T_{θ} are sequentially shown from top to bottom. When T_{θ}≤DTs≤1−T_{θ}, the charging time length and discharging time length of the flying capacitor Cfk are both equal to T_{θ}. When DTs<T_{θ}, the charging time length and discharging time length of the flying capacitor Cfk are both equal to DTs. When DTs>1−T_{θ}, the charging time length and discharging time length of the flying capacitor Cfk are both equal to (1−D)Ts. It can be seen that the charging time length and discharging time length of the flying capacitor may be adjusted through adjusting the magnitude of the duty ratio of the main switch, thereby adjusting the voltage on the flying capacitor. In specific, the change of the duty ratio of any main switch would cause the voltage on the neighboring flying capacitor to change. Taking FIG. 5 as an example, the change of the duty ratio of the main switch Sak would cause the voltages across the neighboring flying capacitors Cf(k−1) and Cfk to change, and the change of the duty ratio of the main switch Sa(k+1) would cause the voltages across the neighboring flying capacitors Cfk and Cf(k+1) to change. On the other hand, the voltage across the flying capacitor Cfk would be affected by the change of the duty ratios of the neighboring main switches Sak and Sa(k+1).

Taking the flying capacitors Cf(k−1), Cfk and Cf(k+1) shown in FIG. 3 as an example, the adjustment value corresponding to each flying capacitor may be acquired according to the adopted control method (using proportional controller as an example) and the actual voltage and reference voltage of the flying capacitor. The specific calculation is exemplified as follows:

$$\begin{matrix}Δ {d}_{k - 1} = Kp ( {V}_{C f ( k - 1 )}^{*} - {V}_{C f ( k - 1 )} ) \\ Δ {d}_{k} = Kp ( {V}_{C f ( k )}^{*} - {V}_{C f ( k )} ) \\ Δ {d}_{k + 1} = Kp ( {V}_{C f ( k + 1 )}^{*} - {V}_{C f ( k + 1 )} )\end{matrix} , \qquad ( 1 )$$

where Δdₖ₋₁, Δdₖ and Δdₖ₊₁ are the adjustment values corresponding to the flying capacitors Cf(k−1), Cfk and Cf(k+1) respectively, Kp is a proportional coefficient, V_{Cf(k-1)}*, V_{Cf(k)}* and V_{Cf(k+1)}* are the reference voltages of the flying capacitors Cf(k−1), Cfk and Cf(k+1) respectively, and V_{Cf(k-1)}, V_{Cf(k)} and V_{Cf(k+1)} are the actual voltages across the flying capacitors Cf(k−1), Cfk and Cf(k+1) respectively.

Please refer to FIG. 1 and FIG. 3. The DCM control method of the present disclosure adopted as the multi-level conversion circuit currently works in DCM is described in detail as follows.

In the DCM control method, firstly, the adjustment values corresponding to all the flying capacitors Cf1, Cf2, . . . , Cf(N−2) respectively are acquired according to the above equation (1). Namely as shown in step S1 in FIG. 1, the adjustment value corresponding to each flying capacitor is acquired according to the actual voltage and reference voltage across each flying capacitor. Then, as shown in step S2 in FIG. 1, regarding any main switch, the duty ratios of driving signals of N−1 main switches are adjusted according to the acquired adjustment values respectively, and the phase-shift angle of driving signals between neighboring main switches are adjusted according to the acquired adjustment values respectively.

In step S2, regarding any main switch, the adjustment trend of the duty ratio when D<1/(N−1) and the adjustment trend of the duty ratio when D>1/(N−1) are different. More detailed, in step S2, when the duty ratios of driving signals of N−1 main switches are adjusted according to the adjustment values under D<1/(N−1), an adjustment of the duty ratio of the kth main switch Sak according to the adjustment value(s) corresponding to the flying capacitor(s) connected to the kth main switch Sak is further included, and the duty ratio of the (N−1)th main switch Sa(N−1) is adjusted according to the adjustment value corresponding to the flying capacitor connected to the (N−1)th main switch Sa(N−1). The specific adjustment is exemplified as follows:

$$\begin{matrix}when D < 1 / ( N - 1 ) , \\ Δ {D}_{k} = p \times ( Δ {d}_{k - 1} - Δ {d}_{k} ) \\ Δ {D}_{k + 1} = p \times ( Δ {d}_{k} - Δ {d}_{k + 1} ) \\ {D}_{k}^{′} = {D}_{k} + Δ {D}_{k} \\ {D}_{k + 1}^{′} = {D}_{k + 1} + Δ {D}_{k + 1}\end{matrix} \qquad ( 2 )$$

where ΔDₖ and ΔDₖ₊₁ are the actual adjustment amounts of duty ratios of the kth main switch Sak and the (k+1)th main switch Sa(k+1) respectively. When D<1/(N−1), p is the proportional coefficient between the actual adjustment amount of the duty ratio and the theoretical adjustment amount of the duty ratio of the kth main switch Sak (namely the difference between the adjustment value corresponding to the k−1th flying capacitor Cfk−1 and the adjustment value corresponding to the kth flying capacitor Cfk), 0≤p≤1. Dₖ and Dₖ′ are the duty ratios of the kth main switch Sak before and after the adjustment respectively, and Dₖ₊₁ and Dₖ₊₁′ are the duty ratios of the (k+1)th main switch Sa(k+1) before and after the adjustment respectively, and Dₖ=Dₖ₊₁=D. In addition, Δdₖ₋₁ is zero when k equals 1, and Δdₖ₊₁ is zero when k equals N−2. According to equation (2), when the actual voltage of the kth flying capacitor Cfk deviates from the reference voltage, the duty ratios of the driving signals of the kth main switch Sak and the k+1th main switch Sa(k+1) needs to be adjusted. The adjustment amount of the duty ratio of the kth main switch Sak is determined by the adjustment value corresponding to the k−1th flying capacitor Cfk−1 and the adjustment value corresponding to the kth flying capacitor Cfk. More detailed, the adjustment amount of the duty ratio of the kth main switch Sak is in proportion to the difference between the adjustment value corresponding to the (k−1)th flying capacitor Cfk−1 and the adjustment value corresponding to the kth flying capacitor Cfk, wherein the proportional coefficient is p, and the adjustment speed of voltage the flying capacitor increases as p increases. In addition, the adjustment amount corresponding to the (k−1)th flying capacitor equals zero when k equals 1.

$$\begin{matrix}when D > 1 / ( N - 1 ) , \\ Δ {D}_{k} = q \times ( Δ {d}_{k - 1} - Δ {d}_{k} ) \\ Δ {D}_{k + 1} = q \times ( Δ {d}_{k} - Δ {d}_{k + 1} ) \\ {D}_{k}^{′} = {D}_{k} + Δ {D}_{k} \\ {D}_{k + 1}^{′} = {D}_{k + 1} + Δ {D}_{k + 1}\end{matrix} , \qquad ( 3 )$$

where q is the proportional coefficient between the actual adjustment amount of the duty ratio and the theoretical adjustment amount of the duty ratio of the kth main switch Sak under D>1/(N−1) (namely the difference between the adjustment value corresponding to the k−1th flying capacitor Cfk−1 and the adjustment value corresponding to the kth flying capacitor Cfk), 0≤q≤1. Different from the case under D<1/(N−1), the adjustment speed of the flying capacitor voltage increases as q decreases under D>1/(N−1). Other factors are the same as that in the case under D<1/(N−1).

In an embodiment, in step S2, no matter D<1/(N−1) or D>1/(N−1), the adjustment of phase-shift angle of driving signals between two neighboring main switches according to the acquired adjustment values further includes the adjustment of phase-shift angle of driving signals between the kth main switch Sak and the k+1th main switch Sa(k+1) according to the adjustment value(s) corresponding to the flying capacitor(s) connected to the kth main switch Sak, and the adjustment amount of the phase-shift angle between the kth main switch Sak and the k+1th main switch Sa(k+1) is in proportion to the adjustment value Δdₖ corresponding to the kth flying capacitor. The adjustment amount of phase-shift angle between the kth main switch Sak and the k+1th main switch Sa(k+1) is a first angle φk1 (namely the phase-shift angle between the kth main switch Sak and the k+1th main switch Sa(k+1) is 360°/(N−1)+φk1). When D<1/(N−1), k1=−k0*Δd_k*360°, where k0 is proportional coefficient, and the adjustment speed of the flying capacitor voltage increases as k0 increases. The “±” of the first angle φk1 is the additional adjustment based on the original phase-shift angle, wherein “−” means moves right and the phase-shift angle gradually increases. In specific, k0 is a constant and 0≤k0≤1, and when p is 1 and k0 is equal to 1, the best adjustment effect can be achieved. Moreover, when D<1/(N−1), the converted value from the first angle φk1 to duty ratio Dφk1 (=k0*Δd_k) cannot exceed the adjustment value Δdₖ corresponding to the kth flying capacitor, otherwise the continuous working state of DCM would be interrupted. Thus, it obtains 0≤k0≤1. At the same time, the magnitudes of coefficients p and k0 both can determine the adjustment speed of the flying capacitor voltage. The larger p is, the faster the adjustment is. The larger k0 is, the faster the adjustment is. Therefore, in order to make the adjustment speed of the flying capacitor voltage as fast as possible, p=1 and k0=1 can be set. When D>1/(N−1), φk1=−k1*Δdₖ*360°, where k1 is proportional coefficient, and the adjustment speed of the flying capacitor voltage increases as k1 increases. In specific, k1 is a constant and 0≤k1≤1, and when q is 1 and k1 is equal to 1, the best adjustment effect can be achieved. Similarly, it is better that the converted value from the first angle φk1 to duty ratio Dφk1 does not exceed the adjustment value Δdₖ corresponding to the kth flying capacitor, so that the continuous working state of DCM would not be interrupted. Thus, it obtains 0≤k0≤1. Furthermore, when D>1/(N−1), the converted value from the first angle φk1 to duty ratio Dφk1 also needs to be greater than the actual adjustment amount, namely Dφk1>ΔDₖ in order to make sure the charging and discharging logic is correct. Thus, Dφk1>ΔDₖ is further obtained. The magnitudes of coefficients p and k1 both can determine the adjustment speed of the flying capacitor voltage. The smaller q is, the faster the adjustment is. The larger k1 is, the faster the adjustment is. Therefore, in order to make the adjustment speed of the flying capacitor voltage as fast as possible, q=0 and k1=1 can be set. Accordingly, it is equivalent to maintain the duty ratios of N−1 main switches unchanged, and only adjusting the phase-shift angle between the drive signals of neighboring main switches.

In an embodiment, in the DCM control method, in order to prevent adjusting the duty ratio from affecting the current in the next switching cycle and further affecting the charging and discharging of the flying capacitor and the steady-state operation of circuit, the absolute value of the adjustment value corresponding to each flying capacitor should be less than or equal to |D−D_{ccm}|, where D_{ccm}=1−(Vin/Vo).

The steps of the CCM control method in the present disclosure are described as follows. In the CCM control method, firstly, the adjustment values corresponding to all the flying capacitors Cf1, Cf2, . . . , Cf(N−2) respectively are acquired according to the above equation (1). Namely as shown in step S3 in FIG. 1, the adjustment value corresponding to each flying capacitor is acquired according to the actual voltage and reference voltage across each flying capacitor. Then, as shown in step S4 in FIG. 1, no matter D<1/(N−1) or D>1/(N−1), the duty ratios of driving signals of N−1 main switches are adjusted according to the acquired adjustment values respectively, and the phase-shift angle of driving signals between neighboring main switches are adjusted according to the acquired adjustment values respectively, wherein when the multi-level conversion circuit switches between DCM and CCM, the duty ratio and phase-shift angle are continuous.

In step S4, the adjustment of the duty ratios of driving signals of N−1 main switches according to the acquired adjustment values further includes an adjustment of the duty ratio of the kth main switch Sak according to the adjustment value(s) corresponding to the flying capacitor(s) connected to the kth main switch Sak, and the duty ratio of the (N−1)th main switch Sa(N−1) is adjusted according to the adjustment value corresponding to the flying capacitor connected to the (N−1)th main switch Sa(N−1). The specific adjustment is exemplified as follows:

$$\begin{matrix}Δ {D}_{k} = r ( Δ {d}_{k - 1} - Δ {d}_{k} ) \\ Δ {D}_{k + 1} = r ( Δ {d}_{k} - Δ {d}_{k + 1} ) \\ {D}_{k}^{′} = {D}_{k} + Δ {D}_{k} \\ {D}_{k + 1}^{′} = {D}_{k + 1} + Δ {D}_{k + 1}\end{matrix} \qquad ( 4 )$$

where Δdₖ₋₁ is zero when k equals 1, and Δdₖ₊₁ is zero when k equals N−2. According to equation (4), the adjustment amount of the duty ratio of the kth main switch Sak is determined by the adjustment value corresponding to the k−1th flying capacitor Cfk−1 and the adjustment value corresponding to the kth flying capacitor Cfk. More detailed, the adjustment amount of the duty ratio of the kth main switch Sak is the difference between the adjustment value corresponding to the (k−1)th flying capacitor Cfk−1 and the adjustment value corresponding to the kth flying capacitor Cfk. In addition, the adjustment amount corresponding to the (k−1)th flying capacitor equals zero when k equals 1. Notably, r represents the proportional coefficient between the adjustment amount of the actual duty ratio and the adjustment amount of the theoretical duty ratio, where 0≤r≤1. The adjustment speed of voltage the flying capacitor increases as r increases.

In an embodiment, in step S4, under CCM, the adjustment of phase-shift angle of driving signals between two neighboring main switches according to the acquired adjustment values further includes the adjustment of phase-shift angle of driving signals between the kth main switch Sak and the (k+1)th main switch Sa(k+1) according to the adjustment value(s) corresponding to the flying capacitor(s) connected to the kth main switch Sak. The adjustment amount of the phase-shift angle between the kth main switch Sak and the (k+1)th main switch Sa(k+1) is a second angle φk2 (namely the phase-shift angle between the kth main switch Sak and the (k+1)th main switch Sa(k+1) is 360°/(N−1)+φk2). The “+” of the second angle φk2 is the additional adjustment based on the original phase-shift angle, wherein “−” means moves right and the phase-shift angle gradually increases. The second angle φk2 is determined by the adjustment value corresponding to the kth flying capacitor Cfk. When D<1/(N−1), φk2=D_{φk2}*360° and D_{φk2}=k2×Δdₖ. When D>1/(N−1), φk2=D_{φk2}*360° and D_{φk2}=k3×Δdₖ. D_{φk2} is the duty ratio corresponding to the second angle, Δdₖ is the adjustment value corresponding to the kth flying capacitor, and k2 and k3 are proportional coefficients. In specific,

$$k 2 = \frac{- 1}{( N - 1 ) D}$$

$$when D \leq 1 / ( N - 1 ) , k 3 = - {[ ( N - 1 ) ( \frac{m + 1}{N - 1} - D ) ]}^{{( - 1 )}^{m + 1}} ] when m / ( N - 1 ) < D \leq ( m + 1 ) / ( N - 1 ) .$$

The details of the operation of multi-level conversion circuit in CCM are disclosed above and omitted herein.

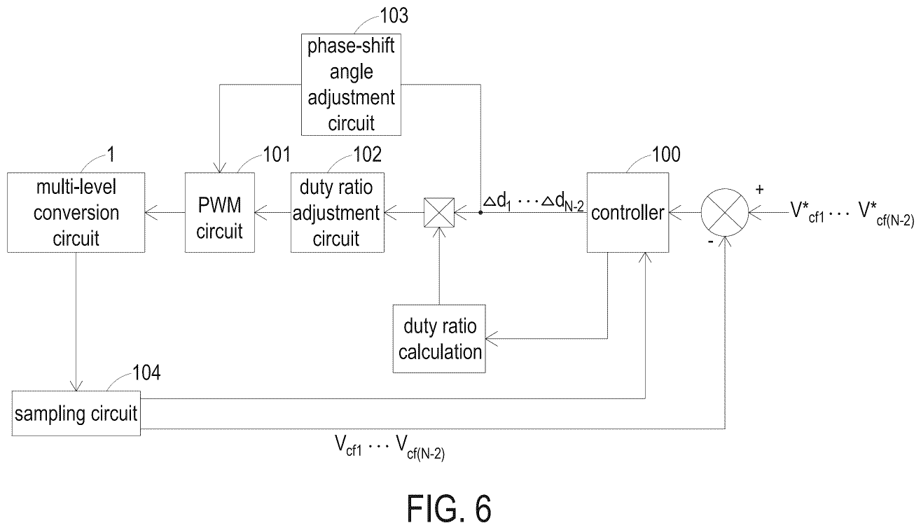

Please refer to FIG. 6 together with FIG. 1, FIG. 2A and FIG. 2B. FIG. 6 is a schematic block diagram illustrating a control unit in FIG. 2A or FIG. 2B. In an embodiment, the control unit, such as the control unit 10 in FIG. 2A or the control unit 20 in FIG. 2B, includes a controller 100, a PWM circuit 101, a duty ratio adjustment circuit 102, a phase-shift angle adjustment circuit 103 and a sampling circuit 104. The controller 100 acquires the adjustment value corresponding to each flying capacitor according to the actual voltage across two terminals of each flying capacitor and the reference voltage. The PWM circuit 101 outputs multiple driving signals to N−1 main switches and N−1 synchronous rectification switches. The duty ratio adjustment circuit 102 is electrically connected to the PWM circuit 102 and configured to drive the PWM circuit 101 to adjust the duty ratio of the kth main switch Sak according to the adjustment value corresponding to the flying capacitor connected to the kth main switch Sak, and adjust the duty ratio of the (N−1)th main switch Sa(N−1) according to the adjustment value corresponding to the flying capacitor connected to the (N−1)th main switch Sa(N−1). The phase-shift angle adjustment circuit 103 is configured to drive the PWM circuit 101 to adjust the phase-shift angle between the driving signals of the kth main switch Sak and the (k+1)th main switch Sa(k+1) according to the adjustment value corresponding to the flying capacitor connected to the kth main switch Sak. The sampling circuit 104 samples the actual voltage across two terminals of each flying capacitor.

As shown in FIG. 6 and the above-mentioned CCM and DCM control methods, in the present disclosure, the adjustment values corresponding to all the flying capacitors respectively are acquired firstly, and then the duty ratio of each switch and the phase-shift angle between driving signals of switches are controlled based on the adjustment values so that the voltage on each flying capacitor is balanced. In FIG. 6, the sampling results received by the controller 100 may include the input voltage Vin, the output voltage Vo or the current flowing through the inductor L, but not limited thereto. The control method for flying capacitor voltage of the present disclosure can realize the balance of the flying capacitor voltage without determining the polarity of the current flowing through the inductor L. Therefore, the charging and discharging logic of the flying capacitor is prevented from being affected by misjudging the polarity of current, thereby improving the reliability of the balance control for flying capacitor voltage. Moreover, when under the DCM control, since in the DCM control method, the phase-shift angle between driving signals of switches are controlled based on the adjustment values, the variation of phase-shift angle under DCM control continues with the variation of the phase-shift angle under CCM control, so as to prevent the nonlinearity of switching between CCM and DCM from causing a non-smooth transition state, thereby improving the jitter of the flying capacitor voltage when switching between CCM and DCM.

The control method for flying capacitor voltage of the present disclosure would be exemplified specifically according to the multi-level DC-DC conversion circuit 1 as follows. The details of the operation of multi-level conversion circuit in CCM are disclosed above, so that the details of the operation of multi-level conversion circuit in DCM are described below.

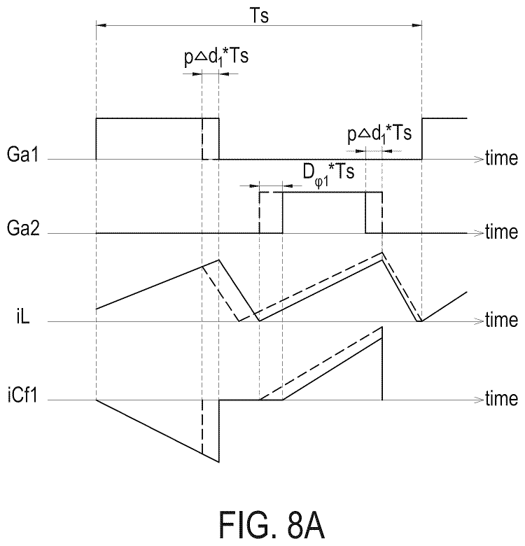

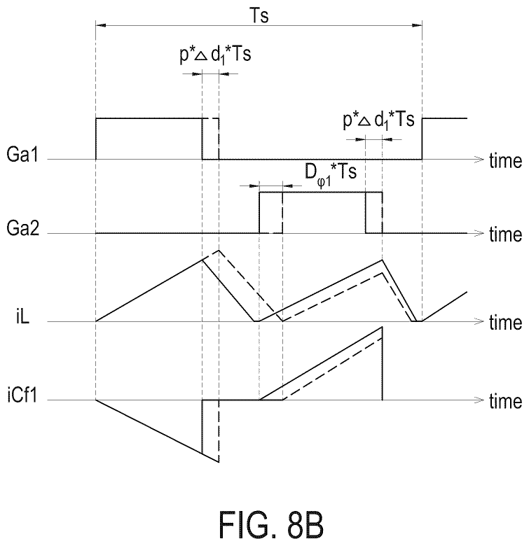

As shown in FIG. 8, when N=3 (i.e., when the number of levels of the multi-level DC-DC conversion circuit 1 is three), the multi-level DC-DC conversion circuit 1 includes two lower switches Sa1 and Sa2, two upper switches Sb1 and Sb2 and one flying capacitor Cf1, and the time length T_{θ} corresponding to the phase-shift angle θ is equal to 0.5 Ts. In this embodiment, the lower switch and the upper switch are regarded as the main switch and the synchronous rectification switch respectively.

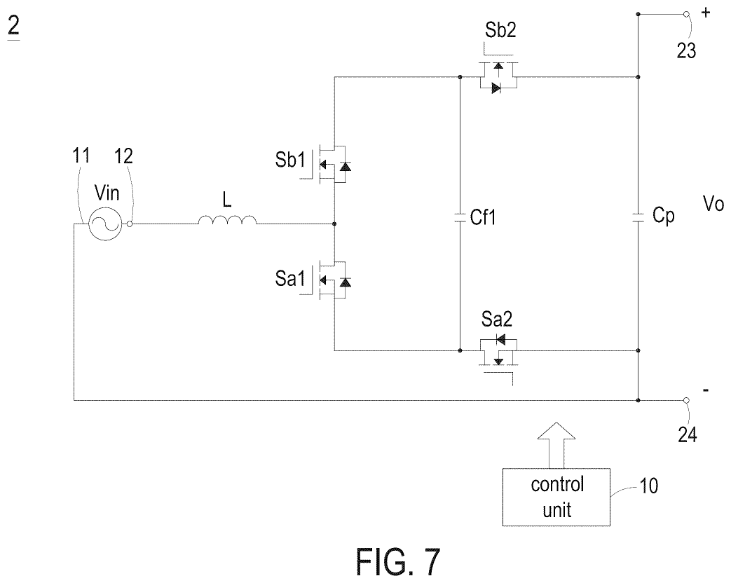

Under the circumstance that the multi-level DC-DC conversion circuit 1 of FIG. 7 works in DCM with D<1/(N−1), the following equation is acquired through the above equation (2):

$$\begin{matrix}Δ {D}_{1} = - p Δ {d}_{1} \\ Δ {D}_{2} = p Δ {d}_{1} \\ {D}_{1}^{′} = {D}_{1} + Δ {D}_{1} = {D}_{1} - p Δ {d}_{1} \\ {D}_{2}^{′} = {D}_{2} + Δ {D}_{2} = {D}_{2} + p Δ {d}_{1}\end{matrix} , \qquad ( 5 )$$

According to the description above, the adjustment value of the phase-shift angle φk1=−k0*Δd₁*360°. Assuming that the flying capacitor Cf1 needs to be charged, Δd₁>0 and the corresponding waveforms in the multi-level DC-DC conversion circuit 1 is shown in FIG. 8A. Assuming that the flying capacitor Cf1 needs to be discharged, Δd₁<0, and the corresponding waveforms in the multi-level DC-DC conversion circuit 1 is shown in FIG. 8B. In FIG. 8A and FIG. 8B, the waveforms before and after adjusting the duty ratio and the phase-shift angle θ are represented by solid lines and dashed lines respectively, Ga1 and Ga2 represent the control signals of the main switches Sa1 and Sa2 respectively, and iCf1 is the current flowing through the flying capacitor Cf1. Further, in FIG. 8A and FIG. 8B, Δd₁ and D_{φ1} indicate the portion of the switching waveforms affected by adjusting the duty ratio and the phase-shift angle, which is the first angle, respectively, wherein |D_{φ1}|=|k0Δd₁|. As shown in FIG. 8A and FIG. 8B, the adjustment value Δd₁ obtained by the flying capacitor Cf1 is used to adjust the duty ratios of the driving signals of the main switches Sa1 and Sa2 respectively, and the phase-shift angle between the driving signals of the two neighboring main switches Sa1 and Sa2 is adjusted according to the acquired adjustment value Δd₁ to ensure that the charging and discharging of the flying capacitor Cf1 are independent. As shown in FIG. 8A, the duty ratio of the main switch Sa1 decreases, the duty ratio of the main switch Sa2 increases, and the phase-shift angle between these two switches decreases, so that the charging increases and the discharging decreases, thereby achieving the charging of the flying capacitor Cf1. As shown in FIG. 8B, the duty ratio of the main switch Sa2 increases, the duty ratio of the main switch Sa1 decreases, and the phase-shift angle between the two increases, so that the discharging increases and the charging decreases, thereby achieving the discharging of the flying capacitor Cf1.

Under the circumstance that the multi-level DC-DC conversion circuit 1 of FIG. 7 works in DCM with D>1/(N−1), the following equation is acquired through the above equation (3):

$$\begin{matrix}Δ {D}_{1} = - q Δ {d}_{1} \\ Δ {D}_{2} = q Δ {d}_{1} \\ {D}_{1}^{′} = {D}_{1} + Δ {D}_{1} = {D}_{1} - q Δ {d}_{1} \\ {D}_{2}^{′} = {D}_{2} + Δ {D}_{2} = {D}_{2} + q Δ {d}_{1}\end{matrix} \qquad ( 6 )$$

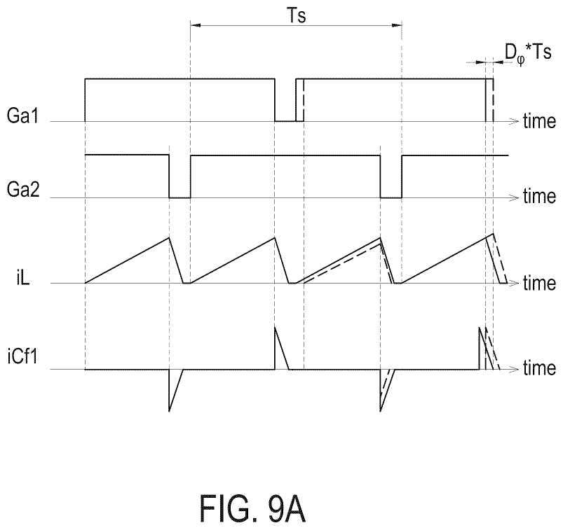

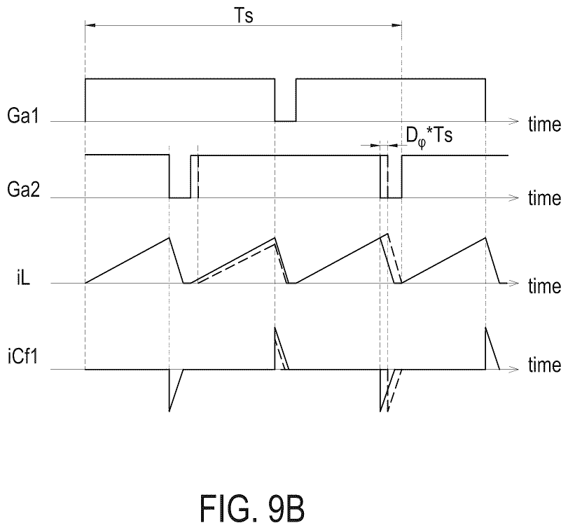

According to the description above, the adjustment value of the phase-shift angle φk1=−k0*Δd₁*360°. Take q=0 as example, namely only the phase-shift angle is adjusted and the duty ratio remains unchanged. Assuming that the flying capacitor Cf1 needs to be charged, Δd₁>0 and the corresponding waveforms in the multi-level DC-DC conversion circuit 1 is shown in FIG. 9A. Assuming that the flying capacitor Cf1 needs to be discharged, Δd₁<0, and the corresponding waveforms in the multi-level DC-DC conversion circuit 1 is shown in FIG. 9B. In FIG. 9A and FIG. 98B, the waveforms before and after adjusting the phase-shift angle θ are represented by solid lines and dashed lines respectively, Ga1 and Ga2 represent the control signals of the main switches Sa1 and Sa2 respectively, and iCf1 is the current flowing through the flying capacitor Cf1. Further, in FIG. 9A and FIG. 9B, D_{φ1} indicates the portion of the switching waveforms affected by adjusting the phase-shift angle, which is the first angle, wherein |D_{φ1}|=|k0Δd₁|. As shown in FIG. 9A and FIG. 9B, the adjustment value Δd₁ obtained by the flying capacitor Cf1 is used to adjust the phase-shift angle between the driving signals of the two neighboring main switches Sa1 and Sa2, and the duty ratio remains unchanged, so as to ensure that the charging and discharging of the flying capacitor Cf1 are independent. As shown in FIG. 9A, the phase-shift angle between the main switches Sa1 and Sa2 decreases, so that the charging increases and the discharging decreases, thereby achieving the charging of the flying capacitor Cf1. As shown in FIG. 9B, the phase-shift angle between the main switches Sa1 and Sa2 increases k1Δd₁, so that the discharging increases and the charging decreases, thereby achieving the discharging of the flying capacitor Cf1. As shown in FIG. 9A and FIG. 9B, the duty ratios of the main switches Sa1 and Sa2 remain unchanged, and the phase-shift angle between driving signals of the two neighboring main switches Sa1 and Sa2 is adjusted according to only the acquired adjustment value Δd₁.

When under DCM control, since in the DCM control method, the phase-shift angle between driving signals of switches are controlled based on the adjustment values, the variation of phase-shift angle under DCM control continues with the variation of the phase-shift angle under CCM control, thereby improving the jitter of the flying capacitor voltage when switching between CCM and DCM. During switching between CCM and DCM, when D<1/(N−1), only k0 is adjusted to ensure |k0|=|k2| as switching, and when D>1/(N−1), only k1 is adjusted to ensure |k1|=|k3| as switching. Accordingly, the transition of the phase-shift angle remains smooth as switching. Regarding the actual adjustment of the duty ratio ΔDₖ, since it is limited by the theoretical adjustment value Δdₖ₋₁−Δdₖ, when D<1/(N−1), only p and r are adjusted to ensure p-r as switching, and when D>1/(N−1), only q and r are adjusted to ensure q=r as switching. Accordingly, the transition of the duty ratio remains smooth as switching.

In summary, the present disclosure provides a control method for flying capacitor voltage and a multi-level DC-DC conversion circuit employing same. The control method and the multi-level conversion circuit may be applied in CCM and DCM to balance the flying capacitor voltage through controlling the duty ratio of switch and the phase-shift angle between switches, so that there is no need to determine the polarity of current, thereby preventing the charging and discharging of the flying capacitor from being affected by misjudging the polarity of current. Consequently, the reliability of the balance control for flying capacitor voltage can be improved. Furthermore, when under DCM control, since in the DCM control method, the phase-shift angle between driving signals of switches are controlled based on the adjustment values, the variation of phase-shift angle under DCM control continues with the variation of the phase-shift angle under CCM control, so as to prevent the nonlinearity of switching between CCM and DCM from causing a non-smooth transition state, thereby improving the jitter of the flying capacitor voltage when switching between CCM and DCM.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for flying capacitor voltage, applied in a multi-level conversion circuit, wherein a number of levels of the multi-level conversion circuit is N which is an integer greater than or equal to three, the multi-level conversion circuit comprises a first input terminal, a second input terminal, an inductor, N−1 lower switches, N−1 upper switches, N−2 flying capacitors, a positive output terminal and a negative output terminal, the first input terminal and the second input terminal are configured to connect to a power source, the positive output terminal and the negative output terminal are configured to provide an output voltage, a first terminal of the inductor is electrically connected to the first input terminal, the N−1 lower switches are connected in series between a second terminal of the inductor and the negative output terminal, a first lower switch and an (N−1)th lower switch of the N−1 lower switches are coupled to the second terminal of the inductor and the negative output terminal respectively, the N−1 upper switches are connected in series between the second terminal of the inductor and the positive output terminal, a first upper switch and an (N−1)th upper switch of N−1 upper switches are coupled to the second terminal of the inductor and the positive output terminal respectively, and a kth flying capacitor of the N−2 flying capacitors is connected between a common connection node of a kth lower switch and a (k+1)th lower switch of the N−1 lower switches and a common connection node of a kth upper switch and a (k+1)th upper switch of the N−1 upper switches, where k is a positive integer less than or equal to N−2, and wherein when the power source is DC power source, the negative output terminal is electrically connected to the second input terminal, and when the power source is AC power source, the multi-level conversion circuit further includes a first input switch and a second input switch, wherein the first input switch is coupled between the first input terminal and the positive output terminal, the second input switch is coupled between the first input terminal and the negative output terminal, and a control signal of the first input switch is complementary to a control signal of the second input switch, the control method comprises steps of:
(a) regarding the N−1 lower switches as N−1 main switches and regarding the N−1 upper switches as N−1 synchronous rectification switches when a potential at the first input terminal is higher than a potential at the second input terminal, and regarding the N−1 lower switches as N−1 synchronous rectification switches and regarding the N−1 upper switches as N−1 main switches when the potential at the first input terminal is lower than the potential at the second input terminal; and
(b) acquiring an adjustment value corresponding to each flying capacitor according to an actual voltage and a reference voltage across two terminals of each flying capacitor, wherein when the multi-level conversion circuit works in a DCM (discontinuous conduction mode), according to the acquired adjustment value, duty ratios of driving signals of the N−1 main switches and phase-shift angles between driving signals of any two neighboring main switches of the N−1 main switches are adjusted respectively.

2. The control method according to claim 1, wherein in the step (b), an adjustment of the duty ratio of the driving signals of the (N−1)th main switch according to the acquired adjustment value further comprises:
adjusting a duty ratio of a kth main switch of the N−1 main switches according to the adjustment value corresponding to the flying capacitor connected to the kth main switch.

3. The control method according to claim 1, wherein in the step (b), an adjustment of the phase-shift angle of the driving signals of any two neighboring main switches of the N−1 main switches according to the acquired adjustment value further comprises:
adjusting a phase-shift angle between driving signals of a kth main switch and a (k+1) main switch of the N−1 main switches according to the adjustment value corresponding to the flying capacitor connected to the kth main switch.

4. The control method according to claim 2, wherein an adjustment amount of the duty ratio of the kth main switch is determined by the adjustment value corresponding to a (k−1)th flying capacitor of the N−2 flying capacitors and the adjustment value corresponding to the kth flying capacitor, wherein the adjustment amount corresponding to the (k−1)th flying capacitor equals zero when k equals 1.

5. The control method according to claim 4, wherein the adjustment amount of the duty ratio of the kth main switch is in proportion to a difference between the adjustment value corresponding to the (k−1)th flying capacitor and the adjustment value corresponding to the kth flying capacitor.

6. The control method according to claim 5, wherein when D<1/(N−1), p is a proportional coefficient, 0≤p≤1, and an adjustment speed of the flying capacitor voltage increases as p increases, and when D>1/(N−1), q is a proportional coefficient, 0≤q≤1, and the adjustment speed of the flying capacitor voltage increases as q decreases, wherein D is the duty ratio.

7. The control method according to claim 4, wherein when the actual voltage of the kth flying capacitor deviates from the reference voltage, the duty ratios of the driving signals of the kth main switch and the (k+1)th main switch are adjusted.

8. The control method according to claim 3, wherein the adjustment amount of the phase-shift angle between the kth main switch and the (k+1)th main switch is in proportion to the adjustment value corresponding to the kth flying capacitor.

9. The control method according to claim 8, wherein when D<1/(N−1), k0 is a proportional coefficient, 0≤k0≤1, and an adjustment speed of the flying capacitor voltage increases as k0 increases, and when D>1/(N−1), k1 is a proportional coefficient, 0≤k1≤1, and the adjustment speed of the flying capacitor voltage increases as k1 increases, wherein D is the duty ratio.

10. The control method according to claim 1, wherein an absolute value of the adjustment value corresponding to each flying capacitor is less than or equal to |D−D_{ccm}|, where D_{ccm}=1−(Vin/Vo), Vin is the input voltage, Vo is the output voltage, and D is the duty ratio.

11. The control method according to claim 1, wherein when the multi-level conversion circuit works in a CCM (continuous conduction mode), according to the acquired adjustment value, the duty ratios of driving signals of the N−1 main switches and the phase-shift angles between driving signals of any two neighboring main switches of the N−1 main switches are adjusted respectively, wherein the duty ratio and the phase-shift angle continue when the multi-level conversion circuit switches between the DCM and the CCM.

12. The control method according to claim 6, wherein when the multi-level conversion circuit works in a CCM, the adjustment amount of the duty ratio of the kth main switch is in proportion to a difference between the adjustment value corresponding to the (k−1)th flying capacitor and the adjustment value corresponding to the kth flying capacitor, where r is a proportional coefficient, 0≤r≤1, and the adjustment amount corresponding to the (k−1)th flying capacitor equals zero when k equals 1, and wherein p and r are adjusted when D<1/(N−1) to ensure p-r as switching between the DCM and the CCM, and q and r are adjusted when D>1/(N−1) to ensure q=r as switching between the DCM and the CCM, thereby continuing the duty ratio as switching between the DCM and the CCM.

13. The control method according to claim 9, wherein the adjustment amount of the phase-shift angle between the kth main switch and the k+1th main switch is in proportion to the adjustment value corresponding to the kth flying capacitor, where k2 is a proportional coefficient when D<1/(N−1), and k3 is a proportional coefficient when D>1/(N−1), wherein when D<1/(N−1), k0 is adjusted to ensure |k0|=|k2| as switching between the DCM and a CCM, and when D>1/(N−1), k1 is adjusted to ensure |k1|=|k3| as switching between the DCM and the CCM, thereby continuing the phase-shift angle as switching between the DCM and the CCM.

14. The control method according to claim 13, wherein q≤k1≤1.

15. A multi-level conversion circuit, wherein a number of levels of the multi-level conversion circuit is N which is an integer greater than or equal to three, and the multi-level conversion circuit comprises:
a first input terminal and a second input terminal, configured to connect to a power source;
a positive output terminal and a negative output terminal, configured to provide an output voltage, wherein the negative output terminal is electrically connected to the second input terminal when the power source is DC power source;
an inductor having a first terminal electrically connected to the first input terminal;
N−1 lower switches connected in series between a second terminal of the inductor and the negative output terminal, wherein a first lower switch and a (N−1)th lower switch of the N−1 lower switches are coupled to the second terminal of the inductor and the negative output terminal respectively;
N−1 upper switches connected in series between the second terminal of the inductor and the positive output terminal, wherein a first upper switch and a (N−1)th upper switch of the N−1 upper switches are coupled to the second terminal of the inductor and the positive output terminal respectively;
N−2 flying capacitors, wherein a kth flying capacitor of the N−2 flying capacitors is connected between a common connection node of a kth lower switch and a (k+1)th lower switch of the N−1 lower switches and a common connection node of a kth upper switch and a (k+1)th upper switch of the N−1 upper switches, and k is a positive integer less than or equal to N−2, and wherein when the power source is AC power source, the multi-level conversion circuit further comprises a first input switch and a second input switch, the first input switch is coupled between the first input terminal and the positive output terminal, the second input switch is coupled between the first input terminal and the negative output terminal, and a control signal of the first input switch is complementary to a control signal of the second input switch; and
a control unit, configured to:
regard the N−1 lower switches as N−1 main switches and regard the N−1 upper switches as N−1 synchronous rectification switches when a potential at the first input terminal is higher than a potential at the second input terminal, and regard the N−1 lower switches as N−1 synchronous rectification switches and regard the N−1 upper switches as N−1 main switches when the potential at the first input terminal is lower than the potential at the second input terminal; and
sample an actual voltage across two terminals of each flying capacitor and acquire an adjustment value corresponding to each flying capacitor according to the actual voltage and a reference voltage of each flying capacitor, wherein when the multi-level conversion circuit works in a DCM (discontinuous conduction mode), according to the acquired adjustment value, duty ratios of driving signals of the N−1 main switches and phase-shift angles between driving signals of any two neighboring main switches of the N−1 main switches are adjusted respectively.

16. The multi-level conversion circuit according to claim 15, wherein the control unit comprises a controller configured to acquire the adjustment value corresponding to each flying capacitor according to the actual voltage across two terminals of each flying capacitor and the reference voltage.

17. The multi-level conversion circuit according to claim 16, wherein when the control unit comprises a PWM circuit configured to output multiple driving signals to the N−1 main switches and the N−1 synchronous rectification switches.

18. The multi-level conversion circuit according to claim 17, wherein the control unit comprises a duty ratio adjustment circuit electrically connected to the PWM circuit and configured to drive the PWM circuit to adjust the duty ratio of a kth main switch of the N−1 main switches according to the adjustment value corresponding to the flying capacitor connected to the kth main switch, and adjust the duty ratio of a (N−1)th main switch of the N−1 main switches according to the adjustment value corresponding to the flying capacitor connected to the (N−1)th main switch.

19. The multi-level conversion circuit according to claim 18, wherein the control unit comprises a phase-shift angle adjustment circuit configured to drive the PWM circuit to adjust the phase-shift angle between the driving signals of the kth main switch and a (k+1)th main switch of the N−1 main switches according to the adjustment value corresponding to the flying capacitor connected to the kth main switch.

20. The multi-level conversion circuit according to claim 18, wherein an adjustment amount of the duty ratio of the kth main switch is determined by the adjustment value corresponding to the k−1th flying capacitor and the adjustment value corresponding to the kth flying capacitor, wherein the adjustment amount corresponding to a (k−1)th flying capacitor of the N−2 flying capacitors equals zero when k equals 1.

21. The multi-level conversion circuit according to claim 20, wherein the adjustment amount of the duty ratio of the kth main switch is in proportion to a difference between the adjustment value corresponding to the (k−1)th flying capacitor and the adjustment value corresponding to the kth flying capacitor.

22. The multi-level conversion circuit according to claim 21, wherein when D<1/(N−1), p is a proportional coefficient, 0≤p≤1, and an adjustment speed of the flying capacitor voltage increases as p increases, and when D>1/(N−1), q is a proportional coefficient, 0≤q≤1, and the adjustment speed of the flying capacitor voltage increases as q decreases, wherein D is the duty ratio.

23. The multi-level conversion circuit according to claim 20, wherein when the actual voltage of the kth flying capacitor deviates from the reference voltage, the duty ratio adjustment circuit drives the PWM circuit to adjust the duty ratios of the driving signals of the kth main switch and a (k+1)th main switch of the N−1 main switches.

24. The multi-level conversion circuit according to claim 19, wherein the adjustment amount of the phase-shift angle between the kth main switch and the (k+1)th main switch is in proportion to the adjustment value corresponding to the kth flying capacitor.

25. The multi-level conversion circuit according to claim 24, wherein when D<1/(N−1), k0 is a proportional coefficient, 0≤k0≤1, and an adjustment speed of the flying capacitor voltage increases as k0 increases, and when D>1/(N−1), k1 is a proportional coefficient, 0≤k1≤1, and the adjustment speed of the flying capacitor voltage increases as k1 increases, wherein D is the duty ratio.

26. The multi-level conversion circuit according to claim 15, wherein an absolute value of the adjustment value corresponding to each flying capacitor is less than or equal to |D−D_{ccm}|, where D_{ccm}=1−(Vin/Vo), Vin is the input voltage, and Vo is the output voltage.

27. The multi-level conversion circuit according to claim 18, wherein when the multi-level conversion circuit works in a CCM (continuous conduction mode), the duty ratio adjustment circuit drives the PWM circuit to adjust the duty ratios of driving signals of the N−1 main switches according to the acquired adjustment value, and the phase-shift angle adjustment circuit drives the PWM circuit to adjust the phase-shift angles between driving signals of any two neighboring main switches of the N−1 main switches, respectively, according to the acquired adjustment value, wherein the duty ratio and the phase-shift angle continue when the multi-level conversion circuit switches between the DCM and the CCM.

28. The multi-level conversion circuit according to claim 22, wherein when the multi-level conversion circuit works in a CCM, the adjustment amount of the duty ratio of the kth main switch is in proportion to a difference between the adjustment value corresponding to the (k−1)th flying capacitor and the adjustment value corresponding to the kth flying capacitor, where r is a proportional coefficient, 0≤r≤1, and the adjustment amount corresponding to the (k−1)th flying capacitor equals zero when k equals 1, and wherein p and r are adjusted when D<1/(N−1) to ensure p-r as switching between the DCM and the CCM, and q and r are adjusted when D>1/(N−1) to ensure q-r as switching between the DCM and the CCM, thereby continuing the duty ratio as switching between the DCM and the CCM.

29. The multi-level conversion circuit according to claim 25, wherein the adjustment amount of the phase-shift angle between the kth main switch and the k+1th main switch is in proportion to the adjustment value corresponding to the kth flying capacitor, where k2 is a proportional coefficient when D<1/(N−1), and k3 is a proportional coefficient when D>1/(N−1), wherein when D<1/(N−1), k0 is adjusted to ensure |k0|=|k2| as switching between the DCM and the CCM, and when D>1/(N−1), k1 is adjusted to ensure |k1|=|k3| as switching between the DCM and the CCM, thereby continuing the phase-shift angle as switching between the DCM and the CCM.

30. The multi-level conversion circuit according to claim 29, wherein q≤k1≤1.

31. The multi-level conversion circuit according to claim 15, wherein the control unit comprises a sampling circuit configured to sample the actual voltage across two terminals of each flying capacitor.
